(19) United States
(12) Patent Application Publication
(10) Pub. No.: US 2014/0258756 A1
(43) Pub. Date: Sep. 11, 2014

(54) METHOD AND APPARATUS FOR OPERATING POWER SAVING MODE OF TERMINAL

(71) Applicant: Samsung Electronics Co., Ltd., Gyeonggi-do (KR)

(72) Inventor: Se-Jin PARK, Gyeonggi-do (KR)

(73) Assignee: Samsung Electronics Co., Ltd., Gyeonggi-do (KR)

(21) Appl. No.: 14/202,671

(22) Filed: Mar. 10, 2014

(30) Foreign Application Priority Data
Mar. 8, 2013 (KR) 10-2013-0025153

(51) Int. Cl. G06F 1/32

(52) U.S. Cl. CPC G06F 1/3234
USPC 713/323

(57) ABSTRACT

Disclosed is a method of operating a power saving mode of a terminal, the method including setting at least one power saving display object to be displayed in the power saving mode; configuring a power saving display object DataBase (DB) including information corresponding to the at least one power saving display object, and updating the information corresponding to the at least one power saving display object; beginning an operation of the power saving mode; and displaying the at least one power saving display object in response to a request for a display operation of the at least one power saving display object.

### PRIORITY

This application claims priority under 35 U.S.C. §119(a) to Korean Application Serial No. 10-2013-0025153, which was filed in the Korean Intellectual Property Office on Mar. 8, 2013, the entire content of which is incorporated herein by reference.

### BACKGROUND

1. Field of the Invention

The present disclosure generally relates to a method and an apparatus for operating a terminal, and more particularly, to a method and an apparatus for operating a power saving mode of a terminal.

2. Description of the Related Art

Recently, various services and additional functions provided by a mobile apparatus have been gradually expanded. Various applications which may be executed in the mobile apparatus have been developed in order to improve an effective value of the mobile apparatus and satisfy various needs of users.

In the mobile apparatus, basic applications provided by the manufacturer of the apparatus and installed in the corresponding apparatus, additional applications downloaded from application sales web sites through the Internet, etc. may be stored and executed. The additional applications may be developed by general developers and registered on the sales web sites. Accordingly, anyone can freely sell applications developed by himself/herself to a user of the mobile apparatus through the application sales web sites. Accordingly, tens of thousands to hundreds of thousands of free or charged applications are provided to current mobile apparatuses according to the type of the apparatus.

Therefore, mobile apparatuses such as smartphones and tablet PCs have stored a large number of applications therein, and shortcut keys for executing the respective applications are displayed in the form of icons on a touch screen of the apparatus. Therefore, a user may touch one of the icons displayed on the touch screen to execute a desired application in the mobile apparatus.

In this way, a problem occurs in that as a number of applications are executed in the mobile apparatus, an operation state or a standby state of hardware configurations (e.g., a touch screen, a wireless LAN module, a short-range communication module, a sensor module, a vibration motor, a speaker, etc.) provided in the apparatus is continuously maintained, causing the power source of the mobile apparatus, which has a limited capacity, to be rapidly consumed.

### SUMMARY

In consideration of the above, in order to allow a user to identify information such as time, a message, a schedule, an unanswered call list, etc. through the mobile apparatus which is maintained in a sleep state, as the user may activate all of the hardware configurations provided in a mobile apparatus, additionally release a pattern lock, and operate an application, etc., by receiving input of a home key or a power key, a problem occurs in that a lot of electric power of the mobile apparatus is unnecessarily consumed.

The present disclosure has been made to address at least the above-described problems and disadvantages, and to provide at least the advantages described below.

Accordingly, an aspect of the present disclosure is to provide a method and an apparatus for operating a power saving mode of a terminal, which can minimize unnecessary power consumption.

Another aspect of the present disclosure is to provide a method and an apparatus for displaying a power saving User eXperience (UX) including information selected in a power saving mode by a user while minimizing an operation of hardware components.

Another aspect of the present disclosure is to provide a method and an apparatus for selectively configuring only an object desired by a user, among objects included in the power saving UX.

Yet another aspect of the present disclosure is to provide a method and an apparatus for providing a plurality of power saving UXs and selectively configuring a key input which may activate each of the plurality of power saving UXs.

According to an aspect of the present disclosure a method of operating a power saving mode of a terminal may include setting at least one power saving display object to be displayed in the power saving mode; configuring a power saving display object DataBase (DB) including information corresponding to the at least one power saving display object, and updating the information corresponding to the at least one power saving display object; beginning an operation of the power saving mode; and displaying the at least one power saving display object in response to a request for a display operation of the at least one power saving display object.

According to another aspect of the present disclosure, a terminal apparatus may include a display unit; an input interface; a memory unit that at least may store a power saving mode operation program; and at least one controller, wherein the at least one controller is configured to execute the power saving mode operation program, and wherein the power saving mode operation program may include a command that sets at least one power saving display object to be displayed in the power saving mode, configures a power saving display object DB including information corresponding to the at least one power saving display object, updates the information corresponding to the at least one power saving display object, begins an operation of the power saving mode, and may display the at least one power saving display object in response to a request for a display operation of the at least one power saving display object.

According to another aspect of the present disclosure a computer readable storage medium may include at least one program, wherein the at least one program may include a command that sets at least one power saving display object to be displayed in a power saving mode, configures a power saving display object DB including information corresponding to the at least one power saving display object, updates the information corresponding to the at least one power saving display object, begins an operation of the power saving mode, and may display the at least one power saving display object in response to a request for a display operation of the at least one power saving display object.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating an apparatus to which a method of operating a power saving mode of a terminal is applied, according to an embodiment of the present disclosure;

FIGS. 2A and 2B are front perspective views illustrating a terminal apparatus to which a method of operating a power saving mode of a terminal is applied, according to an embodiment of the present disclosure;

FIG. 3 is a flowchart illustrating an operation sequence of a method of operating a power saving mode of a terminal according to an embodiment of the present disclosure;

FIG. 4A illustrates an example of a power saving mode setting User Interface (UI) used in a method of operating a power saving mode of a terminal according to an embodiment of the present disclosure;

FIG. 4B illustrates an example of a key setting detail UI used in a method of operating a power saving mode of a terminal according to an embodiment of the present disclosure;

FIG. 4C illustrates another example of a key setting detail UI used in a method of operating a power saving mode of a terminal according to an embodiment of the present disclosure;

FIG. 4D illustrates an example of a power saving display object setting UI used in a method of operating a power saving mode of a terminal according to an embodiment of the present disclosure;

FIG. 4E illustrates another example of a power saving display object setting UI used in a method of operating a power saving mode of a terminal according to an embodiment of the present disclosure;

FIG. 4F illustrates an example of a power saving UX setting UI used in a method of operating a power saving mode of a terminal according to an embodiment of the present disclosure;

FIG. 5 illustrates an example of a power saving display object DataBase (DB) used in a method of operating a power saving mode of a terminal according to an embodiment of the present disclosure; and

FIGS. 6A and 6B are examples of a power saving UX used in a method of operating a power saving mode of a terminal according to an embodiment of the present disclosure.

### DETAILED DESCRIPTION OF EMBODIMENTS OF THE PRESENT DISCLOSURE

Hereinafter, specific embodiments of the present disclosure will be described with reference to the accompanying drawings. However, the present disclosure is not restricted or limited by the described embodiments. The same reference numerals represented in each of the drawings indicate the elements that perform substantially the same functions.

Terms including ordinal numerals such as “first”, “second”, and the like can be used to describe various structural elements, but the structural elements are not limited by these terms. The terms are used only to distinguish one structural element from another structural element. For example, without departing from the scope of the present disclosure, a first structural element may be referred to a second structural element. Similarly, the second structural element also may be referred to as the first structural element. The terms used in this application are for the purpose of describing particular embodiments only and are not intended to limit the disclosure. As used herein, the singular forms are intended to include the plural forms as well, unless the context clearly indicates otherwise.

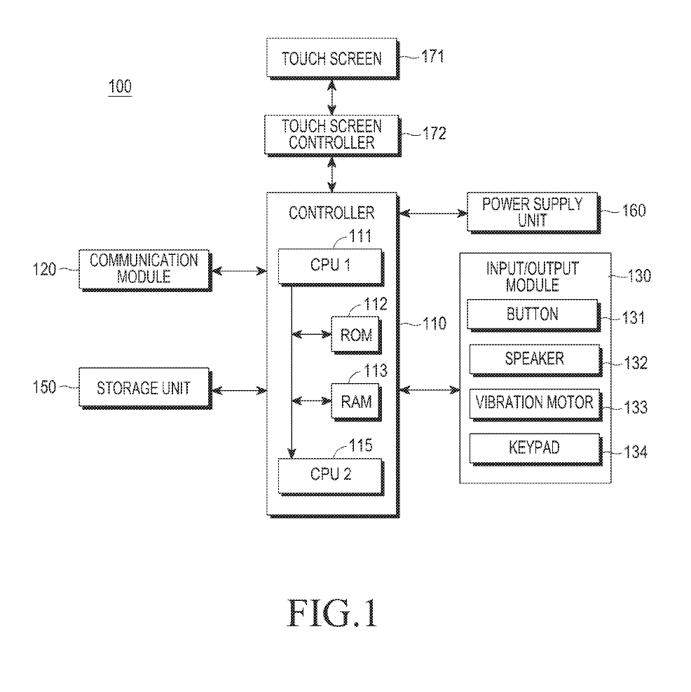

FIG. 1 is a block diagram illustrating an apparatus to which a method of operating a power saving mode of a terminal is applied, according to an embodiment of the present disclosure. Referring to FIG. 1, an apparatus 100 may include a controller 110, a communication module 120, an input/output module 130, a storage unit 150, a power supply unit 160, a touch screen 171, and a touch screen controller 172.

The controller 110 may include a first Central Processing Unit (CPU) 111, a Read-Only Memory (ROM) 112 in which a control program for controlling the apparatus 100 is stored, and a Random Access Memory (RAM) 113 which may store a signal or data input from the outside of the apparatus 100 or is used as a memory region for an operation performed in the apparatus 100. The first CPU 111, the ROM 112, and the RAM 113 may be connected to each other through an internal bus. The controller 110 may be configured by a single core, a dual core, a triple core, or a quad core, and may additionally include a second CPU 115 in addition to the first CPU 111. The second CPU 115 is a CPU provided to consume relatively lower power than that of the first CPU 111.

Further, the controller 110 may control the apparatus 100 to operate in either a normal mode or a power saving mode. The operation of the apparatus 100 in the normal mode is controlled through the first CPU 111, and the operation of the apparatus 100 in the power saving mode is controlled through the second CPU 115. Thus, the controller is connected to the communication module 120, the input/output module 130, the storage unit 150, the power supply unit 160, the touch screen 171, and the touch screen controller 172 and may control operations of these components.

The communication module 120 may include at least one of a cellular module, a wireless LAN module, and a short-range communication module.

The cellular module may allow the apparatus 100 to be connected to an external apparatus through mobile communication using one or more antennas under control of the controller 110. The cellular module may transmit/receives a wireless signal for voice call, video call, a Short Message Service (SMS) or a Multimedia Message Service (MMS) to/from a portable phone, a smart phone, a tablet PC or other apparatuses which have a phone number input to the apparatus 100.

The wireless LAN module may be connected to the Internet at a place where a wireless Access Point (AP) is installed, under control of the controller 110. The wireless LAN module supports the wireless LAN provision (IEEE802.11x) of the Institute of American Electrical and Electronics Engineers (IEEE). The wireless LAN module may operate a Wi-Fi Positioning System (WPS) that identifies position information of a terminal which is provided with the wireless LAN module by using position information provided by a wireless AP wirelessly connected thereto.

The short-range communication module is a module which wirelessly may process the short-range communication with the apparatus 100 under control of the controller 110, and may process communication based on a short-range communication scheme such as Bluetooth communication, Infrared Data Association (IrDA) communication, Wi-Fi-Direct communication, Near Field Communication (NFC), etc.

The input/output module 130 may include at least one of a button 131, a speaker 132, and a vibration motor 133.

The buttons 131 may be formed on a front surface, a side surface or a rear surface of a housing of the electronic device 100, and may include at least one of an electric power/lock button, a volume control button, a menu button, a home button, a back button, and a search button.

The speaker 132 may output sounds corresponding to various signals (e.g., example, a wireless signal, a broadcasting signal, etc.) of the cellular module, the wireless LAN module, and the short-range communication module to the outside of the terminal apparatus 100 under a control of the controller 110. One speaker 132 or a plurality of speakers 132 may be formed on a suitable position or positions of the housing of the apparatus 100.

The vibration motor 133 may convert an electronic signal into mechanical vibration under the control of the controller 110. One vibration motor 164 or a plurality of vibration motors 164 may be formed within the housing of the device 100.

The speaker 132 and the vibration motor 133 may be operated according to a setting condition of a volume operation mode of the apparatus 100. For example, the volume operation mode of the apparatus 100 may include a sound mode, a vibration mode, a sound/vibration mode, and a mute mode, and may be set as one of them. The controller 110 may output a signal that instructs the operation of the speaker 132 or the vibration motor 133 according to a function performed by the apparatus 100, based on the mode to which the volume operation mode is set. For example, the controller 110 may output a voice signal or a vibration signal to the speaker 132 and the vibration motor 133, in response to a touch operation of a user which touches the touch screen 171 and a continuous movement of a touch on the touch screen 171.

The storage unit 150 may store signals or data input/output in response to the operation of the communication module 120, the input/output module 130, or the touch screen 171 under control of the control unit 110. The storage unit 150 may store a control program and an application for controlling the device 100 or the controller 110.

The term “storage unit” may include the storage unit 150, the ROM 112 and the RAM 113 within the controller 110, or a memory card (e.g. an SD card or a memory stick) mounted to the apparatus 100. The storage unit may include a non-volatile memory, a volatile memory, a Hard Disc Drive (HDD) or a Solid State Drive (SSD).

The power supply unit 160 supplies electric power to one or more batteries disposed in the housing of the apparatus 100 under a control of the controller 110. The one or more batteries supply electric power to the electronic device 100. Further, the power supply unit 160 may supply electric power input from an external electric power source through a wired cable connected to a connector provided within the apparatus 100, to the apparatus 100. In addition, the power supply unit 160 may supply electric power wirelessly input from the external electric power source to the apparatus 100 through a wireless charging technology.

The touch screen 171 may display user interfaces corresponding to various services (e.g. voice call, data transmission, etc.), to a user based on an Operating System (OS) of the terminal. The touch screen 171 may transmit an analog signal corresponding to at least one touch input to a user interface to the touch screen controller 172. The touch screen 171 receives inputs of at least one touch through body parts of a user (e.g. fingers), or a touchable input means (e.g. a stylus pen). Further, the touch screen 171 may receive a continuous movement of one touch among the at least one touch. The touch screen 171 may transmit an analog signal corresponding to the continuous movement of the touch input thereto to the touch screen controller 172.

The touch screen 171 may be implemented in, for example, a resistive type, a capacitive type, an infrared type, or an acoustic wave type.

Meanwhile, the touch screen controller 172 may control an output value of the touch screen 171 such that display data provided from the controller 110 may be displayed on the touch screen 171. Further, the touch screen controller 172 may convert analog signals received from the touch screen 171 into digital signals (e.g. X and Y coordinates) and may transmit the digital signals to the controller 110. The controller 110 may control the touch screen 171 by using the digital signal received from the touch screen controller 172. For example, the controller 110 may allow a user to select or execute a shortcut icon displayed on the touch screen 170 in response to a touch event or a hovering event. Further, the touch screen controller 172 may be included in the controller 110.

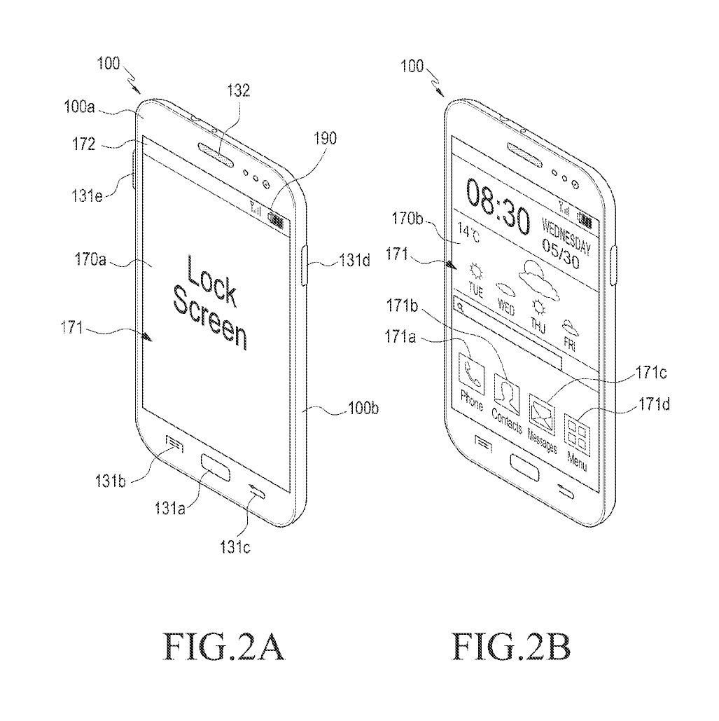

FIGS. 2A and 2B are front perspective views illustrating a terminal apparatus to which a method of operating a power saving mode of a terminal is applied, according to an embodiment of the present disclosure.

Referring to FIG. 2, the touch screen 171 is disposed in the center of the front surface 100a of the apparatus 100. The touch screen 171 is formed in a large size so that the touch screen 171 occupies almost the entire front surface 100a of the apparatus 100. FIG. 2A illustrates an example in which a lock screen 170a is displayed on the touch screen 171. The lock screen 170a is the first screen displayed on the touch screen 171 when the terminal apparatus 100 is turned on, in which the lock screen may provide an environment accessible to the apparatus 100 by inputting security information (e.g., a password, a security pattern, etc.) set by a user. Accordingly, the controller 110 confirms the validity of security information (e.g., a password, a security pattern, etc.) input by a user, and then releases the lock screen, thereby performing an operation of switching to the home screen 170b (see FIG. 2B).

Further, the lock screen 170a may be configured to receive password or a security pattern, and may be configured to be switched to the home screen by a touch input or a drag input of a user without inputting of the password or security pattern when a user does not set separate security information.

Further, the home screen 170b may include several pages of different home screens, and a first home screen among the several pages of different home screens may be a main home screen. Short-cut icons 171a, 171b, and 171c for executing frequently used applications, a main menu switching key 171d, time, weather, etc. may be displayed on the home screen 170b. The main menu switching key 171d may display a menu screen on the touch screen 171. In addition, a status bar 172 that may display a status of the apparatus 100, such as battery charging condition, received signal intensity, current time, and a volume operation mode, may be formed at an upper end of the touch screen 171.

A home button 131a, a menu button 131b, and a back button 131c may be formed at a lower portion of the touch screen 171.

Basically, the home button 131a may display the main home screen on the touch screen 171. For example, when the home button 131a is touched in a state where a home screen different from the main home screen or the menu screen is displayed on the touch screen 171, the main home screen is displayed on the touch screen 171. Further, when the home button 131a is touched while applications are executed on the touch screen 171, the main home screen illustrated in FIG. 2B may be displayed on the touch screen 171. In addition, the home button 131a may be used to display recently used applications or a task manager on the touch screen 171.

The menu button 131b may provide a connection menu which can be used on the touch screen 171. The connection menu may include a widget addition menu, a background changing menu, a search menu, an editing menu, an environment setting menu, etc.

The back button 131c may display the screen which was executed just before the currently executed screen or may terminate the most recently used application.

The speaker 132 may be disposed at an upper center portion of the front surface 100a of the apparatus 100. Further, for example, the power/reset button 131d, the volume button 131e, etc. may be disposed on a lateral surface 100b of the apparatus 100.

In an embodiment of the present disclosure, although it is shown that the apparatus 100 may include the touch screen 171 configured to include a display panel that may output a display signal and a touch screen panel that is capable of detecting a user's input as a display apparatus, and in response to this, it is also shown that the apparatus 100 may include the touch screen controller 172, the present disclosure is not limited thereto. For example, the apparatus 100 may be configured to include the display panel only as a display apparatus, and to include a separate input means, e.g. a keypad, etc.

Hereinafter, the methods according to embodiments of the present disclosure may be implemented in a program command type which may be executed through various computing means, and may be recorded in a computer readable medium. The computer readable medium may include a program command, a data file, a data structure, etc. independently or in combination. The program command recorded in the computer-readable medium may be one which is specifically designed and configured for the present disclosure, or may be well-known to and used by a person ordinarily skilled in the art of computer software.

Further, the methods according to the embodiments of the present disclosure may be implemented in a program instruction form and stored in the storage unit 150 of the apparatus 100, and the program command may be temporarily stored in the RAM 113 included in the controller 110 in order to execute the methods according to the embodiments of the present disclosure. Accordingly, the controller 110 may control hardware components included in the apparatus 100 in response to the program commands according to the methods of the embodiments of the present disclosure, temporarily or continuously store the data produced while executing the methods according to the embodiments in the storage unit 150, and provide UIs required for executing the methods according to the embodiments of the present disclosure to the touch screen controller 172.

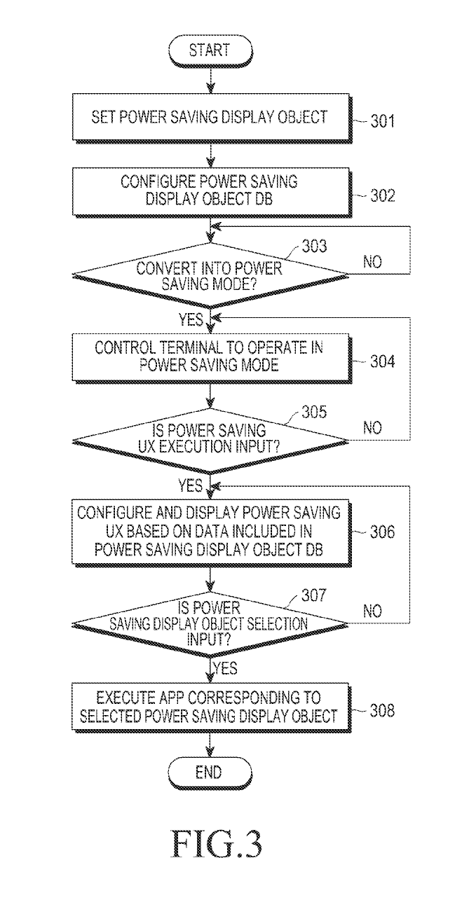

FIG. 3 is a flowchart illustrating an operation sequence of a method of operating a power saving mode of a terminal according to an embodiment of the present disclosure.

Referring to FIG. 3, in step 301, the controller 110 sets a power saving display object to be displayed in a power saving mode through the touch screen 171. For example, the controller 110 may provide power saving display objects which may be included in a power saving UX displayed in the power saving mode, and receives input of at least one power saving display object from a user.

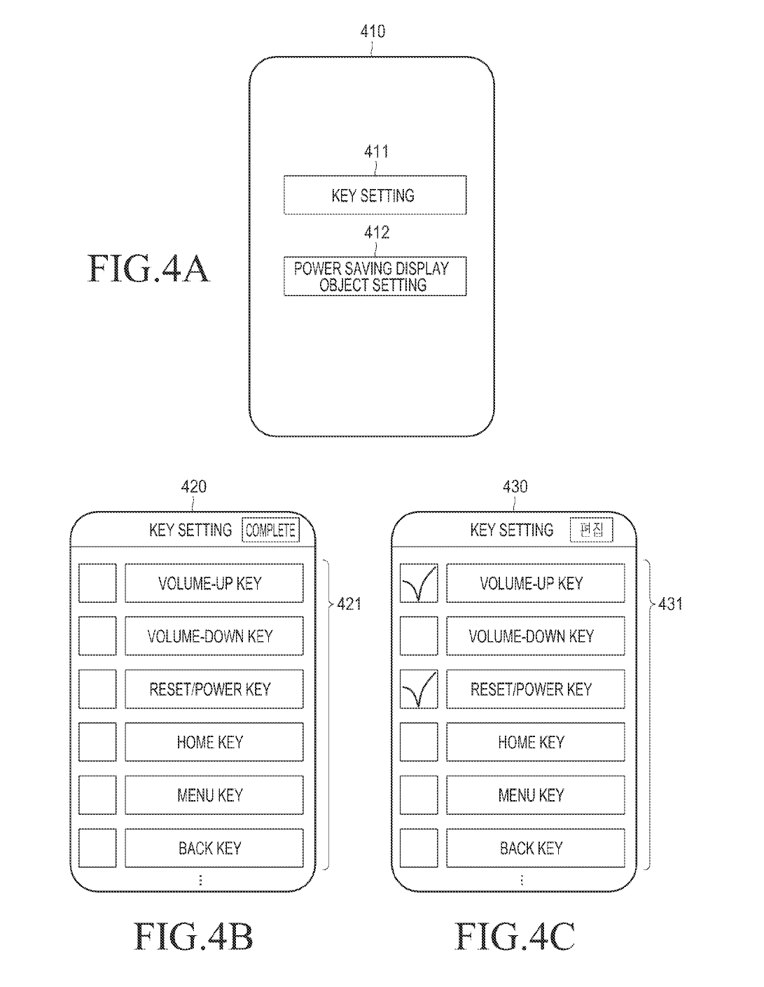

In detail, referring to FIG. 4A, the controller 110 may provide a power saving mode setting UI 410 including the power saving display objects displayed by the power saving UX, to the touch screen 171. The power saving mode setting UI 410 may include a key setting menu 411 which can set a key used for activating the power saving UX in the power saving mode, and a power saving display object setting menu 412 which can set the power saving display object included in the power saving UX.

As seen in FIG. 4B, the controller 110 may provide a key setting detail UI 420 by listing at least one button 131 (or keypad 134) in response to selection of the key setting menu 411 by a user (as indicated by reference numeral 421), and may provide an environment in which a user can set a power saving UX key button used for activating the power saving UX, by selecting at least one of buttons 421 provided by the listing. Further, the key setting detail UI may display at least one preset key button in order to activate the power saving UX (as indicated by reference numeral 431), and may provide an environment which can change or modify at least one preset key button according to necessity, which is like a key setting detail UI 430 illustrated in FIG. 4C.

Meanwhile, referring to FIG. 4D, the controller 110 may provide a power saving display object setting UI 440 in response to selection of the power saving display object setting menu 412 by a user. The power saving display object setting UI 440 is a UI for setting the power saving display objects displayed on the power saving UX, may display at least one object through listing (as indicated by reference numeral 441), and may provide an environment in which a user can select at least one object to be displayed on the power saving UX from at least one of the objects 441 displayed through the listing, and the user can set the selected object as the power saving display object. Further, the power saving display object setting UI may also display a preset power saving display object in order to be displayed on the power saving UX (as indicated by reference numeral 451), and may provide an environment in which a user can change or modify at least one preset power saving display object 451 according to necessity, which is like a power saving display object setting UI 450 illustrated in FIG. 4E.

Furthermore, in a method of operating a power saving mode of a terminal according to an embodiment of the present disclosure, a plurality of power saving UXs may be set. Accordingly, an environment in which a user can set a plurality of power saving UXs key buttons used for activating the plurality of power saving UXs may be provided, and an environment in which a user can set a power saving display object corresponding to each of the plurality of power saving UX key buttons may be provided. For example, as in FIG. 4F, a power saving UX setting UI 460 may be provided as an upper menu of the power saving mode setting UI 410, and the controller 110 may first activate the power saving UX setting UI 460 according to beginning of the setting operation of the power saving display object.

The power saving UX setting UI 460 may include an adding menu 461 which can newly add a power saving UX and at least one power saving UX menu 462 and 463 which can identify and modify the already set power saving UX. When the adding menu 461 is selected, the controller 110 may activate the power saving mode setting UI 410 as a lower menu of the adding menu 461, in which case a UI provided to set the power saving UX key button and the power saving display object may be configured to provide the key setting detail UI 420 and the power saving display object setting UI 440 which can newly select the power saving UX key buttons and the power saving display objects, respectively. Meanwhile, the controller 110 may activate the power saving mode setting UI 410 in response to selection of the already set power saving UX menus 462 and 463, in which case, a UI is provided to set the power saving UX key button and the power saving display object. Further, the UI may be configured to display the already set power saving UX key button and the already set power saving display object, and provide the key setting detail UI 430 and the power saving display object setting UI 450 which can modify or change the already set power saving UX key button and the already set power saving display object.

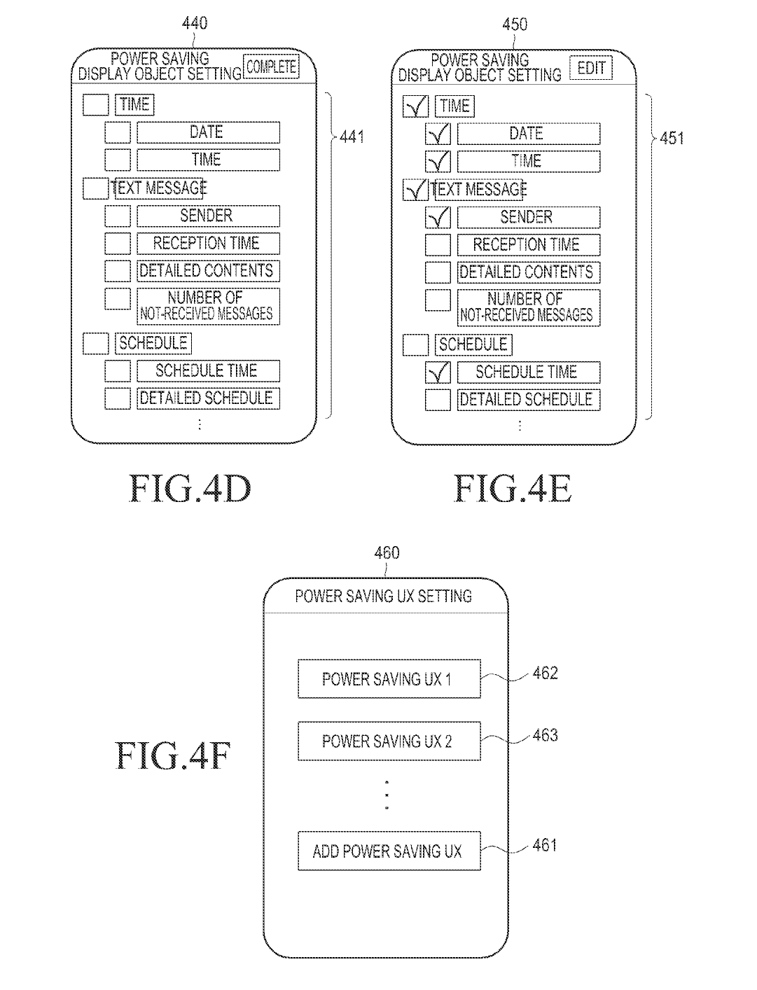

Referring back to FIG. 3, in step 302, the controller 110 identifies the power saving display object set in step 301 and configures a power saving display object database (DB) 501 (See FIG. 5) including data corresponding to the power saving display object. That is, the controller 110 configures the power saving display object DB by reading in data relating to the power saving display object set by a user, from applications corresponding to the set power saving display object, e.g. a messaging application, a voice-call application, a calendar application, etc. Further, the controller 110 updates data for the power saving display object included in the power saving display object DB cyclically or whenever a change event of the data for the power saving display object is generated.

Through the operations of step 301 and step 302, the controller 110 completes setting for the power saving UX.

Next, the apparatus 100 determines whether a request for converting an operation of the apparatus 100 into the power saving mode, by setting of the apparatus 100 or a request of a user is received in step 303. If the request is received, the controller 110 may convert the operation mode of the apparatus 100 into the power saving mode to operate the apparatus 100 in step 304. The power saving mode corresponds to a mode in which electric power needed for operating the apparatus 100 is minimally used, and more particularly, to a mode set to minimize electric power used in the controller 100, the communication module 120, the input/output module 130, the storage unit 150, the touch screen 171, and the touch screen controller 172. In particular, in the power saving mode, the second CPU 115 configured to use relatively low electric power, among the first CPU 111 and the second CPU 115 provided in the controller 110, is set to be activated, and the communication module 120, the input/output module 130, the storage unit 150, the touch screen 171, the touch screen controller 172, etc., are set to be connected to the second CPU 115.

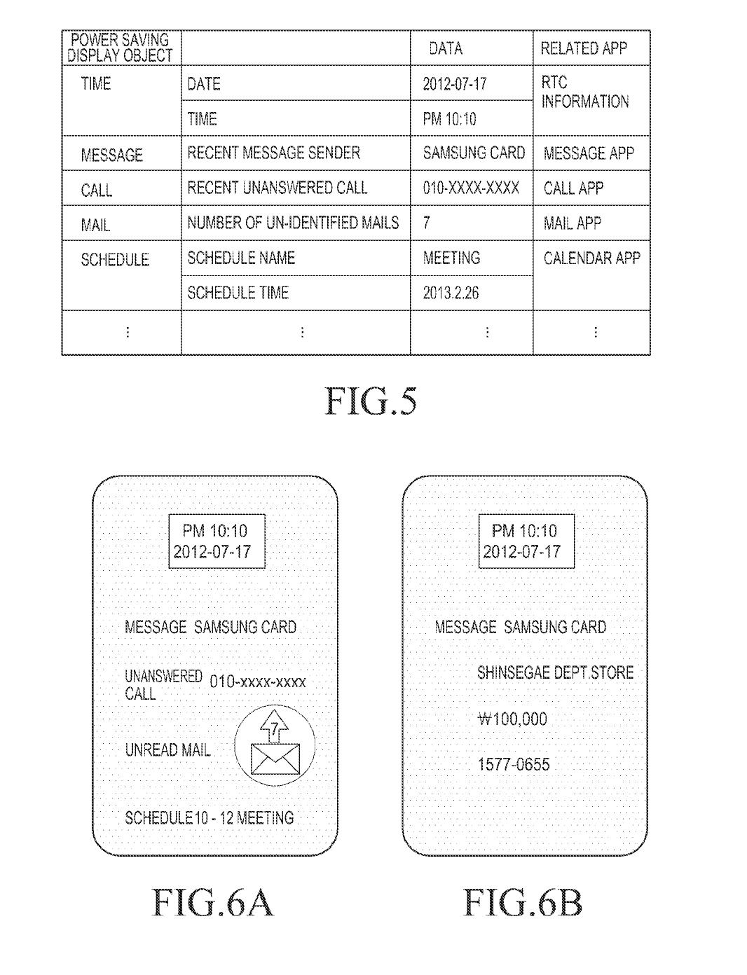

Meanwhile, in step 305, the controller 110 determines if a request for the power saving UX is input. When operating of the power saving UX is requested in a state where the apparatus 100 operates in the power saving mode, that is, when input corresponding to the predetermined power saving UX key button is generated, the controller 100 may activate the corresponding power saving UX in step 306. In detail, the second CPU 115 identifies power saving display object data included in the power saving display object DB and may include the power saving display object data in the power saving UX (for example, See FIGS. 6A and 6B) configured to be operated using low electric power, so as to display the power saving display object data through the touch screen 171 and the touch screen controller 172.

In step 307, the controller 110 determines whether selection of the power saving display object is input. When a user selects the power saving display object in a state where the power saving UX is displayed on the touch screen 171, the controller 110 may convert the operation mode from the power saving mode into the normal mode and executes an operation of an application corresponding to the corresponding power saving display object in step 308. In step 308, as the operation mode is converted from the power saving mode into the normal mode, the CPU used for operating the apparatus 100 is converted from the second CPU 115 to the first CPU 111.

It will be appreciated that the embodiments of the present disclosure may be implemented in a form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. The present disclosure can be realized by a computer or a portable terminal including a controller and a memory, and it can be seen that the memory corresponds to an example of the storage medium which is suitable for storing a program or programs including instructions by which the embodiments of the present disclosure are realized, and is machine readable. Accordingly, the present disclosure may include a program for a code implementing the apparatus and method described in the appended claims of the specification and a machine (a computer or the like)-readable storage medium for storing the program. Further, the program may be electronically transferred by any communication signal through a wired or wireless connection, and the present disclosure appropriately may include equivalents of the program.

Moreover, the above-described mobile apparatus can receive the program from a program provision device which is connected thereto in a wired or wireless manner, and store the program. The program providing apparatus may include a program with instructions to perform a contents protecting method, a memory for storing information necessary for the contents protecting method, a communication unit for performing a wired or wireless communication, and a controller for controlling a transmission of the program. Further, in the case that the mobile apparatus does not request the program providing apparatus to provide the program, for example, that the mobile apparatus is located at a specific position, the program providing apparatus is configured to provide the program to the mobile apparatus through wired or wireless communication.

While the present disclosure has been shown and described with reference to certain embodiments thereof, it will be understood by those skilled in the art that various changes in form and detail may be made therein without departing from the spirit and scope of the disclosure as defined by the appended claims.

What is claimed is:

1. A method of operating a power saving mode of a terminal, the method comprising:
setting at least one power saving display object to be displayed in the power saving mode;
configuring a power saving display object DataBase (DB) including information corresponding to the at least one power saving display object, and updating the information corresponding to the at least one power saving display object;
beginning an operation of the power saving mode; and
displaying the at least one power saving display object in response to a request for a display operation of the at least one power saving display object.

2. The method of claim 1, wherein the information corresponding to the at least one power saving display object is updated as the information corresponding to the at least one power saving display object is changed.

3. The method of claim 1, wherein setting the at least one power saving display object comprises setting a predetermined button which requests the display operation of the at least one power saving display object.

4. The method of claim 1, wherein setting the at least one power saving display object comprises setting at least one predetermined button which requests displaying of the at least one power saving display object, with respect to each of the at least one power saving display object.

5. The method of claim 1, further comprising: releasing the power saving mode, and beginning an operation of an application corresponding to the at least one power saving display object, in response to the selection of the at least one power saving display object which is displayed.

6. A terminal apparatus comprising:
a display unit;
an input interface;
a memory unit that at least stores a power saving mode operation program; and
at least one controller,
wherein the at least one controller is configured to execute the power saving mode operation program, and
wherein the power saving mode operation program comprises a command that sets at least one power saving display object to be displayed in the power saving mode, configures a power saving display object DB including information corresponding to the at least one power saving display object, updates the information corresponding to the at least one power saving display object, begins an operation of the power saving mode, and displays the at least one power saving display object in response to a request for a display operation of the at least one power saving display object.

7. The terminal apparatus of claim 6, wherein the information corresponding to the at least one power saving display object is updated as the information corresponding to the at least one power saving display object is changed.

8. The terminal apparatus of claim 6, wherein the power saving mode operation program further comprises a command that sets a predetermined button which requests the display operation of the at least one power saving display object, in order to set the at least one power saving display object.

9. The terminal apparatus of claim 6, wherein the power saving mode operation program comprises a command that sets at least one predetermined button which requests displaying of the at least one power saving display object, in order to set the at least one power saving display object.

10. The terminal apparatus of claim 6, wherein the power saving mode operation program further comprises a command that releases the power saving mode and begins an operation of an application corresponding to the at least one power saving display object, in response to the selection of the at least one power saving display object which is displayed.

11. A computer readable storage medium having recorded thereon at least one program, the at least one program for performing a method of operating a power saving mode of a terminal, wherein the at least one program comprises a command that sets at least one power saving display object to be displayed in the power saving mode, configures a power saving display object DB including information corresponding to the at least one power saving display object, updates the information corresponding to the at least one power saving display object, begins an operation of the power saving mode, and displays the at least one power saving display object in response to a request for a display operation of the at least one power saving display object.
